(19) United States
(12) Patent Application Publication
(10) Pub. No.: US 2007/0212653 A1
(43) Pub. Date: Sep. 13, 2007

(54) Method and manufacturing nozzle plate, liquid ejection head and image forming apparatus

(75) Inventor: Hisamitsu Hori, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/716,569

(22) Filed: Mar. 12, 2007

(30) Foreign Application Priority Data
Mar. 13, 2006 (JP) 2006-067852

(51) Int. Cl. B41J 2/01

(52) U.S. Cl. 430/320; 347/47

(57) ABSTRACT

The method of manufacturing a nozzle plate includes the steps of: forming a photosensitive film of a negative type photosensitive material on a transparent plate having light transmission characteristics, the photosensitive film being demarcated into an unirradiated region and an irradiated region; and performing exposure of the photosensitive film to light transmitted via a spatial modulation element and the transparent plate, in such a manner that the unirradiated region is not irradiated with the light and the irradiated region is irradiated with the light, wherein, during the exposure of the photosensitive film, change of the unirradiated region is successively performed and change of a time interval when the irradiated region is irradiated with the light is performed in accordance with the change of the unirradiated region.

### BACKGROUND OF THE INVENTION

1. Field of the Invention

The present invention relates to a liquid droplet ejection head, an image forming apparatus, and a method of manufacturing a nozzle plate, and more particularly to a method of manufacturing a nozzle plate used for the ejection surface of a print head of an inkjet type of image forming apparatus, or the like.

2. Description of the Related Art

The print head of an inkjet type image forming apparatus has a plurality of nozzles formed in a nozzle plate which constitutes an ejection surface opposing the recording medium. The shape of nozzles from which ink droplets are ejected toward the recording medium is liable to affect the ink droplet size and the ink droplet ejection speed, and the like, and therefore, the nozzles are required to be processed to a high degree of accuracy.

Japanese Patent Application Publication No. 2004-330636, Japanese Patent Application Publication No. 2002-137381, Japanese Patent Application Publication Nos. 2004-006955 and 2000-040660, and Japanese Patent Application Publication No. 7-329304 disclose methods of manufacturing a nozzle plate of this kind.

FIGS. 22A to 22D are diagrams showing the steps of the manufacturing method disclosed in Japanese Patent Application Publication No. 2004-330636. As shown in FIGS. 22A to 22D, a negative resist layer 103 is formed on the surface of a conductive film 102 formed on top of a non-conductive transparent substrate 101. The negative resist layer 103 is then exposed through a mask 104 having holes 107, with a prescribed gap between the resist layer 103 and the mask 104. In this case, the amount of irradiation light declines gradually at the outside of a hole 107, and thereby the irradiated region has a tapered shape. Therefore, taper-shaped cured materials 106 can be obtained through the subsequent development processing and other steps. Consequently, an electroformed layer 108 is formed to have taper-shaped nozzles, on the basis of the shape of the cured materials 106.

FIGS. 23A to 23D are diagrams showing the steps of manufacturing method disclosed in Japanese Patent Application Publication No. 2002-137381. As shown in FIGS. 23A to 23D, negative resist layers 202 and 203 are formed on the surface of a substrate 201. Thereupon, a diffusion plate 206 is formed across a mask 204 from the negative resist layer 203, and light exposure is carried out. Thereby, the exposed region has a tapered shape in accordance with the diffusion angle of the diffusion plate 206, and accordingly, a taper-shaped resist pattern 207 is obtained through the subsequent development processing and other steps. Consequently, an electroformed layer 208 is formed to have taper-shaped nozzles, on the basis of this shape of the resist pattern 207.

FIG. 24 is a diagram showing a step of the manufacturing method disclosed in Japanese Patent Application Publication Nos. 2004-006955 and 2000-040660. As shown in FIG. 24, this manufacturing method uses a micro mirror array 301 forming a spatial light modulator, an arc light 303, a lens 302, and the like. The light transmitted to a wafer 304 is modulated by the miniature mirror array 301, and a reflected light ray 306 is transmitted to the wafer 304 which is covered with a photoresist. Thus, it is possible to perform light exposure in accordance with a predetermined image pattern which is required for the wafer 304.

FIG. 25 is a diagram showing a step of manufacturing method disclosed in Japanese Patent Application Publication No. 7-329304. As shown in FIG. 25, a photoresist layer 404 is formed across a transparent conductive film 403 and a nickel plating layer 402, from a glass substrate 401. Light exposure is carried out while the glass substrate 401 is inclined by a desired angle of θ with respect to parallel ultraviolet light 406. In so doing, the parallel ultraviolet light 406 is radiated at a desired angle with respect to the glass substrate 401, and the taper-shaped photoresist layer 404 is obtained through the subsequent development processing and other steps. Consequently, taper-shaped nozzles are formed on the basis of this shape of the photoresist layer 404.

However, there are problems of the following kinds in these manufacturing methods in the related art.

Japanese Patent Application Publication No. 2004-330636 discloses that the irradiated region is formed to a tapered shape by carrying out light exposure with a prescribed gap between the resist layer 103 and the mask 104. However, it is difficult to control the spreading of the light so as to form a highly precise tapered shape, simply by adjusting the gap between the mask 104 and the resist layer 103; therefore, it is difficult to form nozzles having a highly precise shape.

Japanese Patent Application Publication No. 2002-137381 discloses that the irradiated region is formed to a tapered shape in accordance with the angle of diffusion, by using the diffusion plate 214. However, it is difficult to control the diffusion angle of the light so as to form a highly precise tapered shape, simply by using a diffusion plate 214; therefore, it is difficult to form nozzles having a highly precise shape. Furthermore, shape variations between nozzles are also liable to occur.

The inventions disclosed in Japanese Patent Application Publication Nos. 2004-006955 and 2000-040660 have an object directed to the formation of a two-dimensional pattern on a wafer 304, and the issue of a method for forming a three-dimensional pattern (nozzle structure, for example) is left out of consideration. Therefore, it is difficult to form a three-dimensional pattern according to Japanese Patent Application Publication Nos. 2004-006955 and 2000-040660.

Japanese Patent Application Publication No. 7-329304 discloses that the parallel ultraviolet light 406 is radiated at a desired angle by inclining the glass substrate 401. However, it is difficult to control the diffusion of the light so as to form a highly precise tapered shape, and therefore it is difficult to form nozzles having a highly precise tapered shape. Furthermore, since the gap between the light source and the glass substrate 401 increases as the angle broadens, then it is necessary to use a light source having good parallelism, and the overall apparatus becomes large in size when a long component is exposed. Furthermore, there is also a problem in that the boundaries of the cross-sectional shape are limited to a linear shape.

### SUMMARY OF THE INVENTION

The present invention has been contrived in view of the foregoing circumstances, an object thereof being to provide a method of manufacturing a nozzle plate, a liquid droplet ejection head and an image forming apparatus, whereby high-precision nozzles can be formed while shape variations between nozzles are prevented.

In order to attain the aforementioned object, the present invention is directed to a method of manufacturing a nozzle plate, the method comprising the steps of: forming a photosensitive film of a negative type photosensitive material on a transparent plate having light transmission characteristics, the photosensitive film being demarcated into an unirradiated region and an irradiated region; and performing exposure of the photosensitive film to light transmitted via a spatial modulation element and the transparent plate, in such a manner that the unirradiated region is not irradiated with the light and the irradiated region is irradiated with the light, wherein, during the exposure of the photosensitive film, change of the unirradiated region is successively performed and change of a time interval when the irradiated region is irradiated with the light is performed in accordance with the change of the unirradiated region.

In this aspect of the present invention, in the exposure step, the photosensitive layer is exposed to the light transmitted via the spatial light modulator, while the exposure time is changed successively as the area of the unirradiated region (the region which is not irradiated with the modulated light) is changed successively. Therefore, it is possible to form a nozzle having a broad-angled tapered shape and having a high freedom of design in terms of the cross-sectional shape. The spatial light modulator can modulate the light, for example.

In this aspect of the present invention, the negative type photosensitive material is exposed to the light transmitted via the spatial light modulator and transmitted through the transparent plate, while the exposure time is changed successively as the area of the unirradiated region is changed successively. In this case, exposure time may be shortened as the area of the unirradiated region is reduced from a maximum area, or exposure time may be increased as the area of the unirradiated region is increased from a minimum area. Thereby, a nozzle can be formed to have a shape in which the nozzle diameter becomes smaller toward the transparent plate, and the ejection port of the nozzle is formed at the interface between the photosensitive film and the transparent plate. Therefore, the opening of the nozzle ejection port has high precision, and the nozzle shape is little affected by variations in the thickness of the photosensitive material.

Furthermore, the irradiation pattern and the exposure time are controlled for each nozzle by means of the spatial light modulator, and beneficial effects can thereby be obtained in that shape variation does not occur between nozzles, for example.

In this aspect of the present invention, a high-precision mask is not required, and therefore a manufacturing step for preparing the mask member can be simplified. A nozzle which includes a straight section and has a broad-angled tapered shape can be formed readily, whereby a high-viscosity ink can be ejected with high precision, at high speed.

Moreover, by controlling the irradiation pattern and the exposure time through the spatial light modulator during the exposure step in such a manner that the opening angle of the nozzle in the vicinity of the ejection port is large, the resistance can be reduced and high-speed refilling of high-viscosity liquid becomes possible. In addition to the control of the exposure time, the irradiation intensity of the light source, or the like, may be controlled.

As a “spatial modulation element”, besides a reflective element such as a mirror array, it is also possible to use a transmitting element such as a liquid crystal shutter.

It is preferable that light transmission of the “negative type photosensitive material” be controlled by blending an absorbent, or the like, into the base resist used for thick film processing (for example, SU-8 manufactured by Kayaku Microchem Corp.).

In this aspect of the present invention, the irradiation direction in the exposure step may be successively changed. For example, a step-wise change of the irradiation direction of exposure may be performed, and a straight-wise change of the irradiation direction of exposure may be performed. The area of the unirradiated region is successively changed, and the exposure time is successively changed in accordance with the area of the unirradiated region. For example, the area of the unirradiated region may be changed in stages, and the exposure time may be changed in stages in accordance with the area of the unirradiated region. In this case, a nozzle whose cross section has a stepped tapered shape can be obtained. However, the present invention is not limited to this, and the area of the unirradiated region may be changed continuously, and the exposure time may be changed continuously in accordance with the area of the unirradiated region. Thereby, a nozzle whose cross section has a linear tapered shape can be obtained.

It is possible to carry out an exposure method which uses the spatial light modulator, only for the vicinity of a nozzle, and to carry out another exposure method which uses a mask, for other portions. Thereby, it is possible to form a highly precise nozzle shape by raising the resolution of the spatial light modulator. Moreover, since the use efficiency of the light source can thus be increased, then it is also possible to reduce the size and the output requirements of the light source, and costs can also be reduced. These beneficial effects are obtained, particularly in the case of nozzles arranged in a matrix configuration, since the nozzle interval is further larger than the diameter of the nozzle opening.

The direction of the change of the unirradiated region may be a direction perpendicular to the irradiation direction of the exposure.

In order to attain the aforementioned object, the present invention is also directed to a method of manufacturing a nozzle plate, the method comprising the steps of: forming a photosensitive film of a positive type photosensitive material on a transparent plate having light transmission characteristics, the photosensitive film being demarcated into an unirradiated region and an irradiated region; performing exposure of the photosensitive film to light transmitted via a spatial modulation element and the transparent plate, in such a manner that the unirradiated region is not irradiated with the light and the irradiated region is irradiated with the light; developing the photosensitive film after the exposure of the photosensitive film; and electroforming a metal member by using the photosensitive film which has been developed for a mold, wherein, during the exposure of the photosensitive film, change of the unirradiated region is successively performed and change of a time interval when the irradiated region is irradiated with the light is performed in accordance with the change of the unirradiated region.

In this aspect of the present invention, the photosensitive material is exposed to the light transmitted via the spatial light modulator, while the exposure time is changed successively as the area of the unirradiated region is changed successively. Therefore, it is possible to form a nozzle having a broad-angled tapered shape and having a high freedom of design in terms of the cross-sectional shape.

In this aspect of the present invention, the positive type photosensitive material is exposed to the light transmitted via the spatial light modulator and through the transparent plate, while exposure time is changed successively as the area of the unirradiated region is changed successively. In this case, exposure time may be shortened as the area of the unirradiated region is successively reduced from a maximum area, or exposure time may be increased as the area of the unirradiated region is successively increased from a minimum area. Thus, the photosensitive film can be developed to have a cross-sectional shape in which the diameter becomes smaller toward the transparent plate. Thereupon, a metal is electroformed by using the developed photosensitive film as a mold. Thus, a nozzle whose diameter becomes smaller toward the transparent plate can be obtained, and the ejection port of the nozzle is formed at the interface between the transparent plate and the electroformed metal. In this aspect of the present invention, the opening of the nozzle ejection port has high precision, and the nozzle shape is little affected by variations in the thickness of the photosensitive material.

Moreover, by controlling the irradiation pattern and the exposure time through the spatial light modulator, beneficial effects are obtained in that shape variation does not occur between nozzles.

In this aspect of the present invention, a high-precision mask is not required, and therefore a manufacturing step for preparing the mask member can be simplified. A nozzle having a cross-sectional shape which is partially linear and which has a broad-angled tapered shape can be formed readily, whereby high-viscosity ink can be ejected with high precision, at high speed.

Moreover, in this aspect of the present invention, a nozzle plate made of metal material is manufactured by reducing and depositing metal in an electroforming process, and therefore it is possible to provide a nozzle plate having high rigidity and good wetting properties.

Here, desirably, the “positive type photosensitive material” has a luminous transmittance controlled by blending an absorbent, or the like, into the base resist used for thick film processing (for example, PMER manufactured by Tokyo Ohka Kogyo Co., Ltd.).

Preferably, during the exposure of the photosensitive film, the change of the unirradiated region is successively performed in such a manner that the unirradiated region becomes narrower successively; and during the exposure of the photosensitive film, the change of the time interval when the irradiated region is irradiated with the light is performed in such a manner that the time interval is shortened in accordance with narrowing of the unirradiated region.

In this aspect of the present invention, the unirradiated region becomes successively smaller. In other words, the irradiated region which is irradiated with the light modulated by the spatial light modulator is extended successively toward the center of the unirradiated region, while the outer edge of the irradiated region is maintained. Moreover, since the exposure time is reduced successively according to the area of the unirradiated region, it is possible to form a nozzle (a hole) having a shape in which the nozzle diameter is reduced successively toward the transparent plate. Since the minimum area of the photosensitive material that forms the ejection port of the nozzle is exposed to the modulated light in the final sequence, then it is possible to form the ejection port of the nozzle with high precision.

Moreover, when irradiation under the condition of the maximum area of the unirradiated region is carried out initially, the photosensitive material is irradiated for a long exposure time, and the exposure light penetrates the photosensitive material. In this case, the amount of irradiated light can be measured and the irradiation pattern can be determined by determination equipment, and accordingly, the irradiation time and the irradiation pattern of the light transmitted via the spatial light modulator can be corrected on the basis of these measurement and determination results.

For example, the smaller the cross sectional of the unirradiated region is, the shorter the irradiation time for the exposure is. In this case, the irradiation time for the exposure is reduced successively as the unirradiated region is reduced from the maximum.

Preferably, at least one of the change of the unirradiated region and the change of the time interval is controlled in accordance with characteristics of the light which passes through the photosensitive film.

In this aspect of the present invention, it is possible to control the irradiation pattern of the light modulated by the spatial light modulator in accordance with the shape of the light actually radiated onto the photosensitive material, and therefore variations in shape between the nozzles can be suppressed. For example, desirably, the irradiation pattern of the modulated light is controlled in accordance with the light transmitted through the photosensitive material which is monitored for each nozzle, by using a light receiving sensor, such as an image sensor.

Moreover, in cases where the exposure time is controlled by means of the spatial light modulator, it is possible to correct variations in the output of the light source, or variations in the transmissivity of the transparent plate or the transmissivity of the photosensitive material, for each nozzle. Hence, a stable nozzle shape can be formed.

Preferably, the method of manufacturing a nozzle plate further comprises the step of forming a first groove having a diameter smaller than a maximum diameter of the unirradiated region, in a surface of the photosensitive film reverse to a surface of the photosensitive film on which the transparent plate is arranged.

Preferably, the method of manufacturing a nozzle plate further comprises the step of forming a first groove having a diameter smaller than a maximum diameter of the unirradiated region, in a surface of the metal member reverse to a surface of the metal member on which the transparent plate is arranged.

In these aspects of the present invention, even in a case where a corresponding member is bonded with adhesive to the surface of the nozzle plate reverse to the surface where the transparent plate is bonded, a surplus adhesive flows into the first groove and there is no occurrence of adhesive flowing into the nozzle and giving rise to blockages. Therefore, high precision of the nozzle shape can be maintained. Moreover, the presence of the first groove also makes it possible to alleviate a distortion caused by stress due to difference in the coefficient of linear expansion between the nozzle plate and the corresponding member. Therefore, the nozzle shape is preserved in a stable fashion. This is particularly beneficial in the case of a nozzle plate having long dimensions.

Preferably, a cross-sectional shape of the unirradiated region which has a maximum space differs from a cross-sectional shape of the unirradiated region which has a minimum space.

In this aspect of the present invention, the shape of the unirradiated region is altered. For example, the cross-sectional shape of the ejection port of a nozzle which is formed when the unirradiated region has the minimum area can be a circular shape, and the cross-sectional shape of the ejection port of the nozzle which is formed when the unirradiated region has the maximum area can be the shape corresponding to the member connected with the nozzle. Thus, the flow of ink in the nozzle is facilitated by altering the cross-sectional shapes of the unirradiated region, and therefore the air bubble expulsion characteristics and the ink flow characteristics are stabilized.

Preferably, the unirradiated region has a projecting section which extends outward; and a phase of the projecting section of the unirradiated region changes successively in accordance with the change of the unirradiated region.

In this aspect of the present invention, since the nozzle is formed to have a spiral-shaped groove, a rotational force is applied to the ink when the ink flows inside the nozzle, and hence the flight direction of an ink droplet can be stabilized yet further.

Preferably, the method of manufacturing a nozzle plate further comprises the step of forming a second groove in a surface of the photosensitive film on which the transparent plate is arranged.

Preferably, the method of manufacturing a nozzle plate further comprises the step of forming a second groove in a surface of the metal member on which the transparent plate is arranged.

In these aspects of the present invention, the wiping characteristics and the trapping characteristics of an ink droplet on the nozzle surface are improved.

In order to attain the aforementioned object, the present invention is also directed to a liquid ejection head comprising a nozzle plate manufactured by any one of the above-mentioned methods of manufacturing a nozzle.

In order to attain the aforementioned object, the present invention is also directed to an image forming apparatus comprising the liquid ejection head described above.

According to the present invention, it is possible to form a high-precision nozzle and avoid variations in shape between nozzles.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1 is an overall compositional diagram of an apparatus which is available for a method of manufacturing a nozzle plate according to a first embodiment;

FIG. 2 is a flowchart showing steps of manufacturing a nozzle plate according to the first embodiment;

FIGS. 3A to 3D are illustrative diagrams of multiple irradiation by a mirror array;

FIGS. 4A to 4D are cross-sectional diagrams of a nozzle having a spiral shape;

FIG. 5 is a flowchart showing a procedure for correcting light exposure;

FIGS. 6A and 6B are illustrative diagrams of light exposure for forming grooves using a mask;

FIG. 7 is an illustrative diagram of nozzle positions and an irradiation area;

FIG. 8 is a diagram showing a photoresist after a developing process and a post-baking;

FIG. 9 is a diagram showing a nozzle plate completed by the method of manufacture according to the first embodiment;

FIG. 10 is a flowchart showing steps of manufacturing a nozzle plate according to a second embodiment;

FIGS. 11A to 11D are illustrative diagrams of multiple irradiation by a mirror array;

FIGS. 12A and 12B are illustrative diagrams of light exposure for forming grooves using a mask;

FIG. 13 is a diagram showing a photoresist after a developing process and a post-baking;

FIG. 14 is a diagram showing the state after carrying out Ni eutectoid plating;

FIG. 15 is a diagram showing the state after carrying out Ni electroforming;

FIG. 16 is a diagram showing a nozzle plate completed by the method of manufacture according to the second embodiment;

FIG. 17A is a plan view perspective diagram showing an embodiment of the composition of a print head;

FIG. 17B is a principal enlarged view of FIG. 17A;

FIG. 17C is a plan view perspective diagram showing a further embodiment of the structure of a head;

FIG. 18 is a cross-sectional view along line 18-18 in FIG. 17A;

FIG. 19 is a diagram showing the arrangement of ink chamber units;

FIG. 20 is a general schematic drawing of an inkjet recording apparatus;

FIG. 21 is a principal plan diagram showing the peripheral area of a print unit of an inkjet recording apparatus;

FIGS. 22A to 22D are diagrams showing the steps of a method of manufacture in the related art;

FIGS. 23A to 23D are diagrams showing the steps of another method of manufacture in the related art;

FIG. 24 is a diagram showing a step of another method of manufacture in the related art; and

FIG. 25 is a diagram showing a step of another method of manufacture in the related art.

### DETAILED DESCRIPTION OF THE PREFERRED EMBODIMENTS

### Method for Manufacturing Nozzle Plate

Firstly, a method of manufacturing a nozzle plate which is one of characteristics of an embodiment of the present invention is described below.

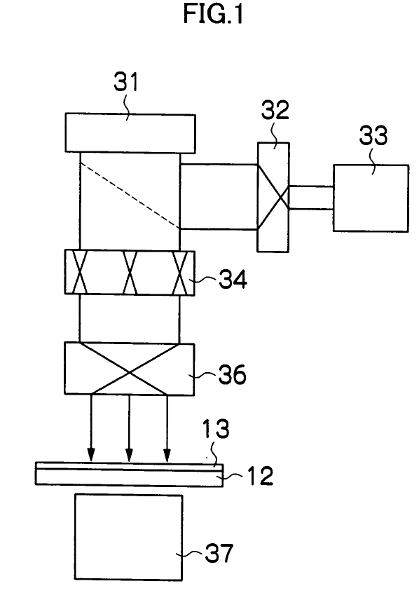

FIG. 1 is an overall compositional diagram of an apparatus which achieves a method of manufacturing a nozzle plate according to a first embodiment. As shown in FIG. 1, this apparatus includes a mirror array 31, a beam expander 32, a solid-state UV laser 33, a micro lens array 34, a projecting lens system 36, a transparent substrate 13 covered with resist 12, a photo sensor 37, and the like.

The ultraviolet light emitted from the solid-state UV laser 33 is expanded by the beam expander 32, and the light is then reflected toward the mirror array 31. The ultraviolet light reflected by the mirror array 31 is modulated to have an irradiation pattern for forming nozzles, by means of the mirror array 31. The ultraviolet light then goes through the micro lens array 34, and the magnification of the light is then adjusted by the projection lens system 36. Then, the modulated light is radiated on and through the transparent substrate 13 covered with resist 12.

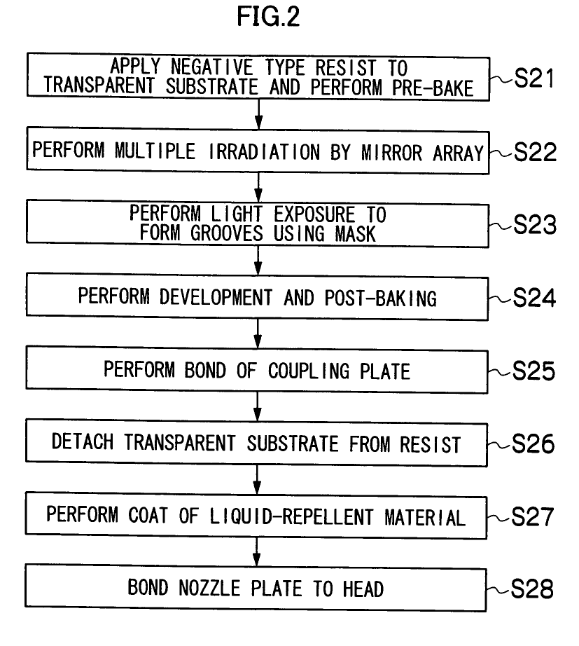

FIG. 2 is a flowchart (illustrative diagram) showing steps of manufacturing a nozzle plate according to the first embodiment. As shown in FIG. 2, in the method of manufacturing a nozzle plate according to the first embodiment, firstly, in a step of applying a photosensitive material, negative type resist 12 is applied to the transparent substrate 13 and pre-baking is carried out (step S21). It is also possible to apply the negative type resist 12 in the form of a sheet, to the transparent substrate 13. By performing pre-baking with respect to the negative type resist 12 and the transparent substrate 13, it is possible to causing the solvent to evaporate from the resist 12 so as to improve adhesion between the negative type resist 12 and the transparent substrate 13.

Thereupon, in a light exposure step, multiple irradiation is carried out by means of the mirror array 31 (step S22). One of the characteristics of the present embodiment is multiple irradiation carried out by means of the mirror array 31 at step S22. This multiple irradiation is described below in detail.

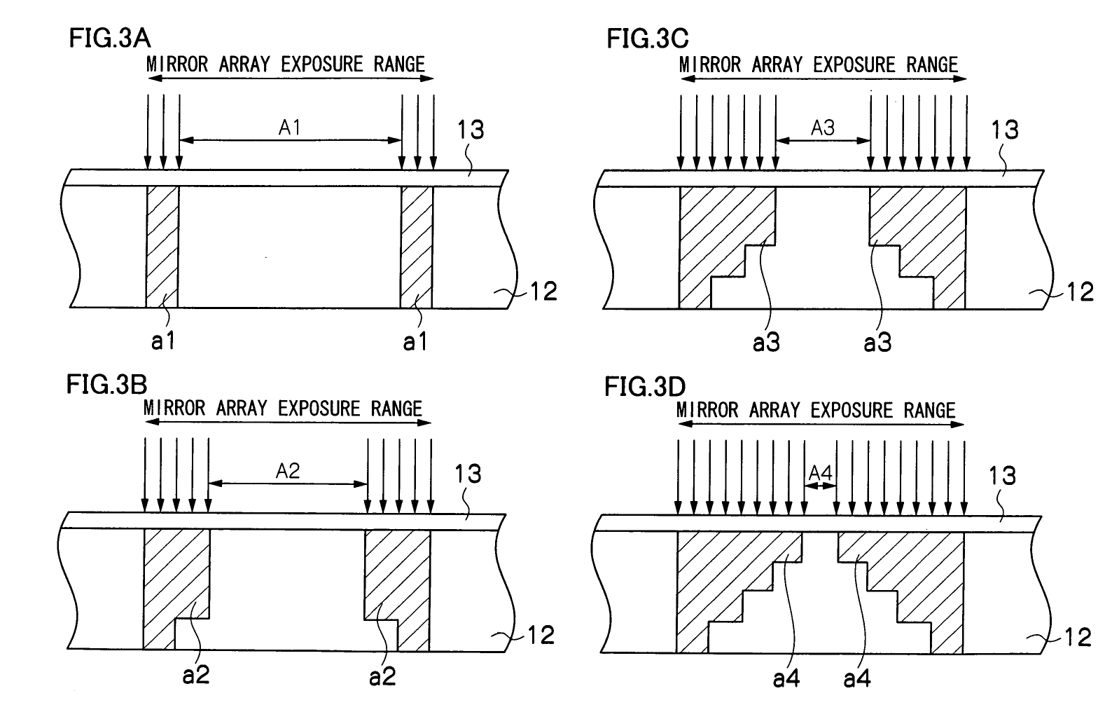

FIGS. 3A to 3D are illustrative diagrams of multiple irradiation by the mirror array 31. As shown in FIG. 3A, a prescribed irradiated region of the resist 12 is exposed to the light modulated by the mirror array 31, from the transparent substrate side of the resist 12 (through the transparent substrate 13). The modulated light is radiated on a prescribed range to be exposed. In this case, the irradiation pattern is controlled by the mirror array 31 so as not to radiate exposure light onto a region (unirradiated region) Al. In so doing, a curing reaction occurs only in the region of the resist 12 where the exposure light is radiated, outside of the region Al. Therefore, firstly, the resist in the region al indicated by the hatching in FIG. 3A is cured.

Thereupon, as shown in FIG. 3B, the light exposure of the resist 12 is carried out through the transparent substrate 13 by means of the mirror array 31, in a similar fashion to FIG. 3A. In this case, similarly to FIG. 3A, the irradiation pattern is controlled by the mirror array 31 so as not to radiate the exposure light onto a region A2 of the resist 12. The region A2 is controlled so as to be narrower than the region A1 (in FIGS. 3A and 3B, the region A2 has a width smaller than the region A1). Furthermore, the amount of light is controlled, in such a manner that the light reaches a prescribed position inside the resist 12 in terms of the thickness direction of the resist 12 (and does not pass through the resist 12 beyond the prescribed position) and the exposure progress stops at the prescribed position inside the resist 12 in terms of the thickness direction of the resist 12. Thereby, a new curing reaction is produced in the region of the resist 12 where exposure light is newly radiated. Therefore, the resist in the region a2 indicated by the newly hatched area in FIG. 3B is cured.

Thereupon, as shown in FIG. 3C, a region (unirradiated region) A3 that is not irradiated with the modulated light is provided, similarly to FIG. 3B. Exposure is controlled in such a manner that the region A3 is narrower than the region A2 in the breadthways direction. Furthermore, the amount of light is controlled in such a manner that the light reaches a prescribed position inside the resist 12 in terms of the thickness direction of the resist 12 (and does not pass through the resist 12 beyond the prescribed position) and exposure progress stops at the prescribed position inside the resist 12 in terms of the thickness direction of the resist 12. Therefore, the resist in the region a3 indicated by the newly hatched area in FIG. 3C is cured.

Thereupon, as shown in FIG. 3D, a region (unirradiated region) A4 that is not irradiated with exposure light is provided, similarly to FIG. 3C. Exposure is controlled in such a manner that the region A4 is narrower than the region A3 in the breadthways direction. Furthermore, the amount of light is controlled in such a manner that the light reaches a prescribed position inside the resist 12 in terms of the thickness direction of the resist 12 (and does not pass through the resist 12 beyond the prescribed position) and exposure progress stops at the prescribed position inside the resist 12 in terms of the thickness direction of the resist 12. Therefore, the region a4 (indicated by the newly hatched area in FIG. 3D) of the resist 12 is cured.

As described above, light exposure is carried out through the transparent substrate 13 by means of the mirror array 31 while the unirradiated region (regions a1 to a4) in the resist 12 is successively narrowed in the breadthways direction by means of the mirror array 31. Thereby, as shown in FIG. 3D, the boundary of the region of cured resist 12 has a stepped shape from the surface on the opposite side from the transparent substrate 13, to the surface on the side of the transparent substrate 13 (in other words, the stepped shape is formed through the entire thickness of the resist 12). By increasing the number of steps, the boundary of the region of cured resist 12 can be formed to have a tapered shape.

Thus, it is possible to form high-accuracy nozzles 15 having a broad-angled tapered shape with a high design freedom of the cross-sectional shape. Furthermore, since the portion which is to form the ejection port of a nozzle 15 is formed in the vicinity of the transparent substrate 13 (at the interface between the transparent substrate 13 and the resist 12), then the ejection port of the nozzle 15 has high precision, and a shape of the ejection port is little affected by variations in the thickness of the resist 12.

For example, the following process can be carried out according to the multiple exposure using the mirror array 31 as described above. In cases where the total thickness of the resist 12 is 20 to 30 μm, it is possible to form nozzles by changing the area of the unirradiated region each time the exposure progresses by 0.1 to 1 μm in the thickness direction.

It is also possible to carry out light exposures with reversing the order of the regions (unirradiated regions) not to be irradiated with the modulated light (in other words, the light exposures can be carried out in the order of A4, A3, A2, and A1). In this case, under a condition of the unirradiated region A4, for example, light is also radiated on the regions which are to be irradiated under conditions of the unirradiated regions A3, A2 and A1. Accordingly, variations are liable to occur in the extent of the curing reaction, because of the effects of the irradiation history.

The unexposed portion which is not subjected to light exposure by the mirror array 3 I-, at the vicinity of the transparent substrate 13, corresponds to the ejection port. The unexposed portion which is not subject to light exposure by the mirror array 31, at the other surface of the resist 12 corresponds to an ink inlet port. Cross-sectional shapes (cross-sectional shapes of nozzles) of these unexposed portions of the resist 12 can be designed freely. Hence, it is also possible to match the cross-sectional shape of the ink inlet port with the shape of the corresponding member (such as a coupling plate). Consequently, beneficial effects are obtained in that the expulsion of air bubbles inside the ink is improved and the flow of ink is stabilized.

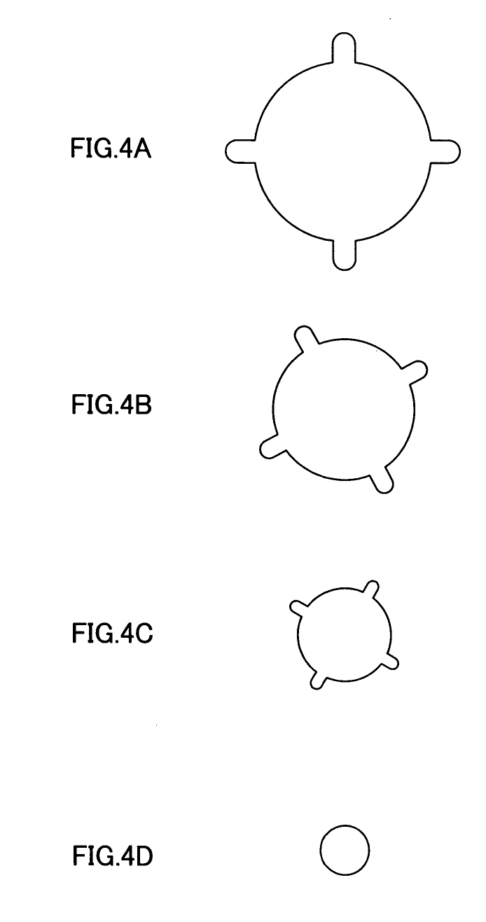

Moreover, the nozzle may be formed to have spiral-shaped grooves partially in the inner surface of the nozzle, by means of the mirror array 31. More specifically, when light exposures outside of the unirradiated regions A1 to A4 are carried out, the irradiation patterns are controlled in such a manner that each nozzle has a cross-sectional shape with projections as shown in FIGS. 4A to 4D. Thereby, a rotational force is applied to the ink, so that the deviation of ink droplet flight is prevented and the ink droplet flight is stabilized further.

In the present embodiment, the light exposure is corrected for each nozzle. The corresponding correction procedure is described below. Firstly, in order to perform this correction, as shown in FIG. 1, the light sensor 37 is disposed across the transparent substrate 13 covered with the resist 12, from the mirror array 31. The light sensor 37 detects the light transmitted through the resist 12, of the multiple irradiation light.

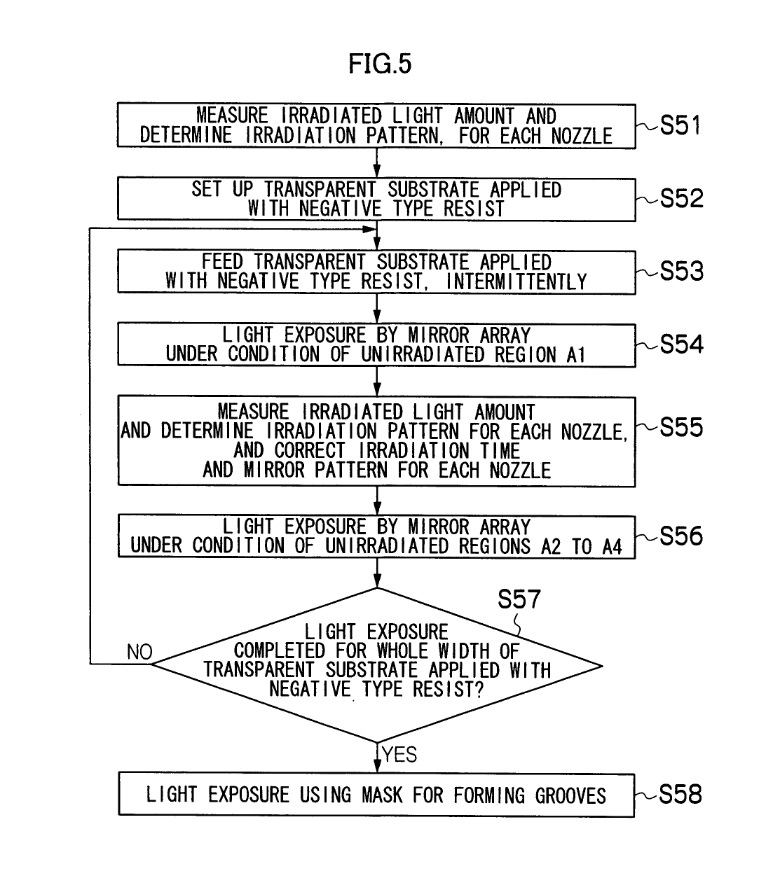

FIG. 5 is a flow diagram of the procedure for correcting the light exposure. As shown in FIG. 5, firstly, an irradiation measurement step is carried out (step S51). More specifically, the irradiation light amount is measured and the irradiation pattern is determined by the light sensor 37, at the portions corresponding to nozzles, in a state where the transparent substrate 13 covered with the resist 12 is not present. In this case, if the measurement values lies outside a prescribed range, then it is judged that the apparatus is out of order.

Thereupon, the transparent substrate 13 coated with the resist 12 is disposed at a prescribed position (step S52), and it is then moved to a target position for light exposure using the mirror array 31, by intermittent feeding in the direction of the longer edges (of the transparent substrate 13 coated with the resist 12) (step S53). Thereupon, the procedure advances to a light exposure step (step S54). More specifically, light exposure is carried out by means of the mirror array 31, under conditions of the unirradiated region A1 shown in FIG. 3A.

Thereupon, the procedure advances to a light exposure correction step (step S55). More specifically, the irradiation light amount is measured and the irradiation pattern is determined by the light sensor 37 for each portion where a nozzle is to be formed. On the basis of these measurement and determination results, the exposure time and the irradiation pattern (mirror pattern) are then corrected for each portion where a nozzle is to be formed.

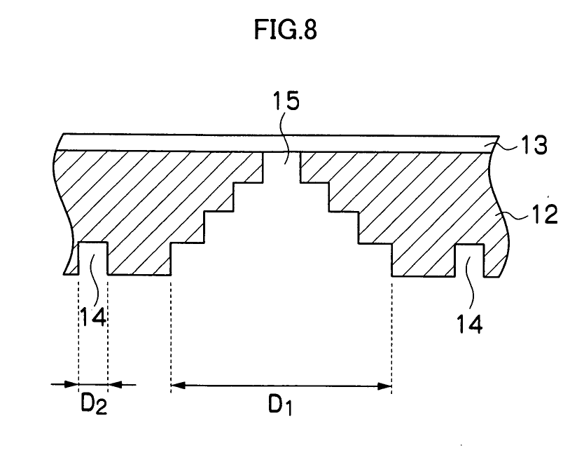

Thereupon, the resist 12 is subjected to light exposure while the unirradiated regions A2 to A4 are changed in accordance with the setting conditions (step S56). Thereupon, it is judged whether or not exposure has been completed for the entire transparent substrate 13 coated with resist 12 (step S57). If it is judged that exposure has been completed (“YES” verdict in step S57), then the procedure advances to a step for performing further light exposure (hereinafter, referred to as “mask light exposure”) using a mask in order to form grooves 14 (which is described later with reference to FIG. 8) (step S58). On the other hand, if it is judged that exposure has not been completed (“NO” verdict in step S57), then the procedure returns to S52, the transparent substrate 13 coated with the resist 12 is fed intermittently in the direction of the long edges and moved to the next target position where light exposure is to be carried out, and the procedure then advances to steps S53 to S57. By carrying out correction for each nozzle 15 by means of this method, beneficial effects are obtained in that there is no occurrence of shape variations between the nozzles 15.

Desirably, the light modulated by the mirror array 31 is radiated only on the vicinity of the nozzles 15 and the other parts are exposed by using a mask (mask light exposure rather than mirror array exposure is carried out for the other parts). In this case, it is possible to form highly precise nozzle shapes by raising the resolution of the mirror array 31. Moreover, it is also possible to reduce the size and output power of the light source, by increasing the use efficiency of the light source, and hence costs can also be reduced. Beneficial effects are obtained, particularly in the case of nozzles arranged in a matrix configuration, since the nozzle interval is relatively large in comparison with the nozzle opening.

As described above, multiple irradiation is carried out by means of the mirror array 31 at step S22 in FIG. 2.

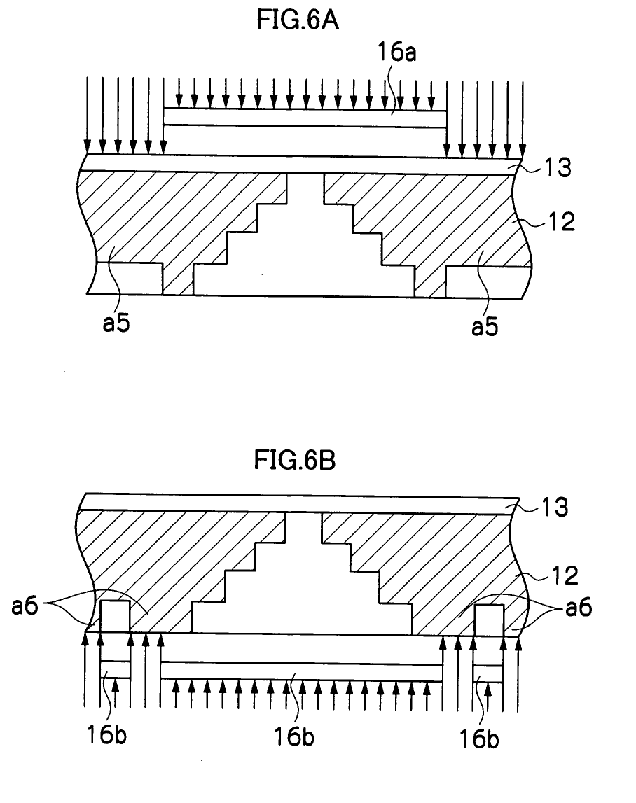

Thereupon, the mask light exposure is carried out in order to form grooves 14 (step S23). FIGS. 6A and 6B are illustrative diagrams of the mask light exposure for forming the grooves 14.

As shown in FIG. 6A, a mask 16a is provided on the side of the transparent substrate 13, and exposure is then carried out. In this case, the exposure is carried out for the entire area of the transparent substrate 13, in just one operation (one-shot exposure). The amount of light is controlled in such a manner that the light reaches a prescribed position inside the resist 12 in terms of the thickness direction of the resist 12 (and does not pass through the resist 12 beyond the prescribed position) and the exposure progress stops at the prescribed position inside the resist 12 in the thickness direction of the resist 12. More specifically, the irradiation intensity and the exposure time are adjusted in such a manner that the exposure progress stops at a position corresponding to the bottom of the groove 14 described later. Thereby, the region a5 of the resist 12 indicated by hatching in FIG. 6A is newly cured. It is also possible to use a mask having a corrected light transmittance.

Thereupon, as shown in FIG. 6B, a mask 16b is provided across the resist 12 from the transparent substrate 13 and one-shot exposure is then carried out. In this case, the mask 16b having a width and a figure required for forming the grooves 14 is prepared. In so doing, the region a6 of the resist 12 indicated by hatching in FIG. 6B is newly cured.

As described above, in step S23 in FIG. 2, the mask light exposure is carried out in order to form the grooves 14. The grooves 14 are formed so that the maximum diameter D₁ of a nozzle 15 (the diameter of the region A1 of the unirradiated region) is larger than the diameter D₂ of a groove 14 (see FIG. 8).

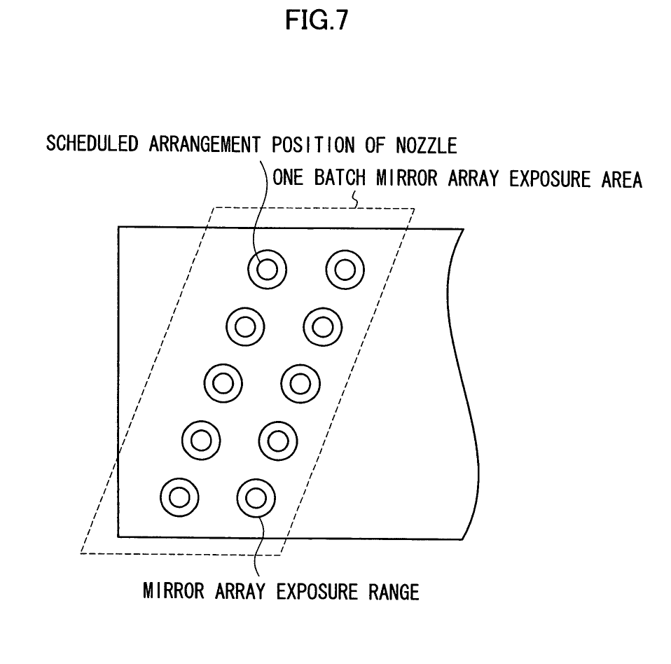

FIG. 7 is a diagram showing the relationship among the irradiation area and the scheduled nozzle positions where nozzles are intended to be arranged. As shown in FIG. 7, the area (mirror array exposure range) irradiated with the light modulated by the mirror array is provided for each nozzle, and the area (one batch mirror array exposure area) which the modulated light can cover in one operation, includes the scheduled nozzle positions where nozzles are intended to be arranged. By intermittently feeding the transparent plate 13 covered with the resist 12 in the lateral direction in FIG. 7, the entire area of the transparent plate 13 can be exposed to the modulated light. The area where the exposure is carried out with the mask includes the scheduled nozzle positions.

Thereupon, in a developing step, a developing process and post-baking are carried out (step S24). By carrying out this developing process, the portions of the resist 12 that have not been cured at steps S22 and S23 is removed. Furthermore, by carrying out the post-baking, the solvent is made to evaporate from the resist 12 and the adhesion characteristics are improved. As a result, the resist 12 is formed to have nozzles 15 with a shape in which the internal diameter reduces successively toward the transparent substrate 13, as shown in FIG. 8.

Next, in a flow channel substrate bonding step, a coupling plate 17 is bonded to the resist 12 thus developed, on the surface that is on the opposite side of the resist 12 from the surface on which the transparent substrate 13 is arranged (step S25 in FIG. 2). The coupling plate 17 is a plate having coupling holes which connect pressure chambers with the nozzles in order to supply ink to the nozzles 15. An epoxy-based adhesive, or the like, is used in the bonding method.

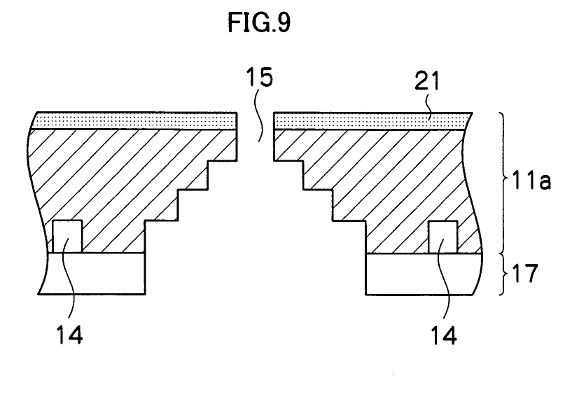

Next, in a transparent substrate detachment step, the transparent substrate 13 is detached from the resist 12 (step S26). Thereupon, a liquid repelling film forming step is carried out (step S27). More specifically, a liquid repelling agent 21 (e.g., a film lacking an affinity for the liquid to be used) is applied onto the surface that has been covered with the transparent substrate 13 (i.e., the surface having the nozzle ejection ports). The liquid repelling agent 21 contains fluoride, and it has a thickness of 1 to 3 μm. FIG. 9 shows the completed nozzle plate 11a.

Thereupon, in a head bonding step, a print head is bonded to the completed nozzle plate 11a (step S28 in FIG. 2).

The method of manufacturing a nozzle plate according to a first embodiment is described above.

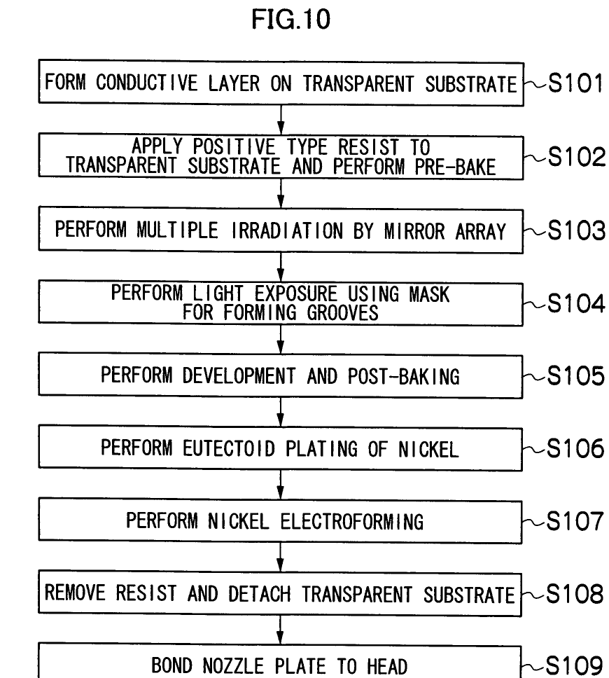

Next, a method of manufacturing a nozzle plate according to a second embodiment is described below. The second embodiment differs from the first embodiment in that it uses a positive type resist 18, Ni eutectoid plating and Ni electroforming. FIG. 10 is an illustrative diagram showing steps of manufacturing a nozzle plate according to the second embodiment. As shown in FIG. 10, the steps for manufacturing the nozzle plate according to the second embodiment include a conductive layer forming step of forming a conductive layer on a transparent substrate 13 (step S101), followed by a photosensitive film forming step of applying a positive type resist 18 and carrying out pre-baking (step S102), and a light exposure step of carrying out multiple irradiation by means of a mirror array 31, in order to form nozzles (step S103).

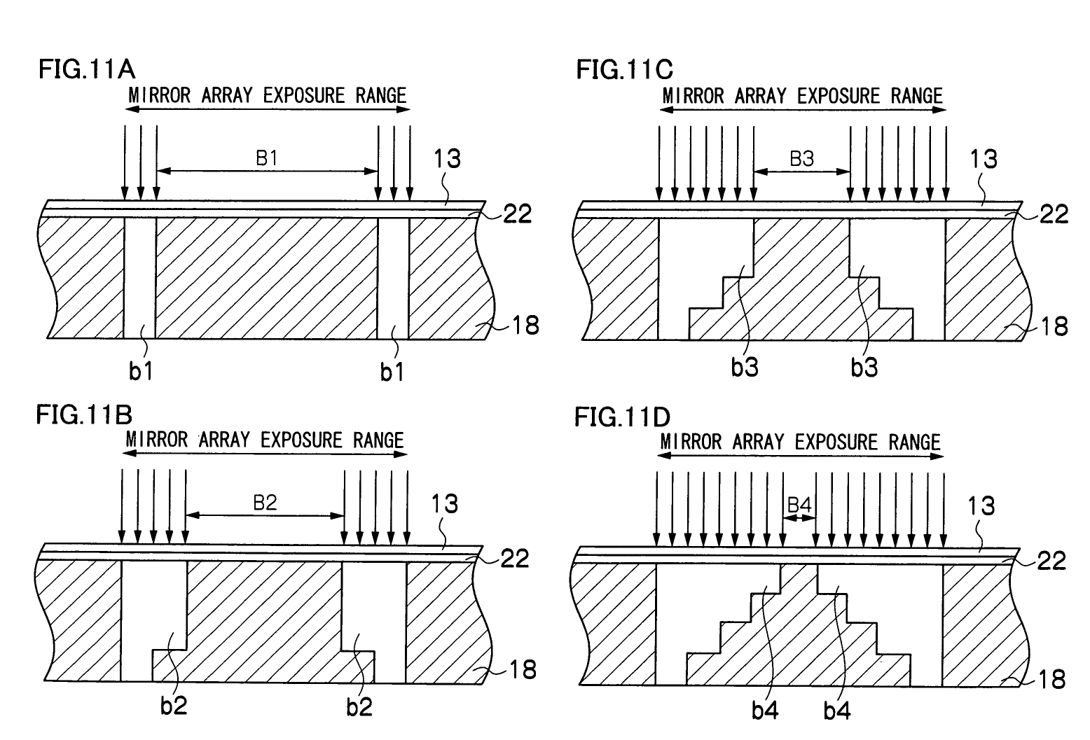

FIGS. 11A to 11D are illustrative diagrams of multiple irradiation by the mirror array in the step S103.

As shown in FIG. 11A, the transparent substrate 13 is prepared through the steps S101 and S102. Firstly, a conductive layer of ITO (Indium Tin Oxide film), or the like, is formed on the transparent substrate 13 at S101. Thereupon, a positive type resist 18 is applied (on the conductive layer) on the transparent substrate 13 and pre-baking is carried out at S102. Light exposure of the resist 18 is then carried out by means of the mirror array 31, from the transparent substrate 13 side of the resist 18 (through the transparent substrate 13). In this case, a region B1 of the resist 18 where the light modulated by the mirror array 31 is not radiated is provided. In so doing, a softening reaction is produced only in the region of the resist 18 which is irradiated with the light modulated by the mirror array 31. Therefore, firstly, the resist in the region b1 indicated by the non-hatched area in FIG. 11A is softened.

Thereupon, as shown in FIG. 11B, similarly to the case shown in FIG. 11A, light exposure of the resist 18 is carried out by means of the mirror array 31, through the transparent substrate 13. In this case, a region B2 of the resist 18 where the light modulated by the mirror array 31 is not radiated is provided. Here, the region B2 is controlled so as to be narrower than the region B1 (in FIGS. 11A and 11B, the width of region B2 is smaller than the width of region B1). Furthermore, the amount of light is controlled in such a manner that the light reaches a prescribed position inside the resist 18 in terms of the thickness direction of the resist 18 (and does not pass through the resist 18 beyond the prescribed position) and the exposure progress stops at the prescribed position within the resist 18 in the thickness direction of the resist 18.

Thereby, a softening reaction is produced only in the region of the resist 18 which has been newly irradiated with the modulated light. Therefore, the resist in the region b2 indicated by the newly non-hatched area in FIG. 11B is softened.

Thereupon, as shown in FIG. 11C, similarly to the case shown in FIG. 11B, a region (unirradiated region) B3 which is not irradiated with the modulated light is provided, and exposure is controlled in such a manner that the region B3 is narrower than the region B2 in the breadthways direction. Furthermore, the amount of light is controlled in such a manner that exposure progress stops at a prescribed position inside the resist 18 in terms of the thickness direction of the resist 18. In so doing, the resist in the region b3 indicated by the newly non-hatched area in FIG. 11C is softened.

Thereupon, as shown in FIG. 11D, similarly to the case shown in FIG. 11C, a region (unirradiated region) B4 which is not irradiated with the modulated light is provided, and exposure is controlled in such a manner that the region B4 is narrower than the region B3 in the breadthways direction. Furthermore, the amount of light is controlled in such a manner that exposure progress stops at a prescribed position inside the resist 18 in terms of the thickness direction of the resist 18. Thereby, the resist in the region b4 indicated by the newly non-hatched area in FIG. 11D is softened.

As described above, light exposure is carried out by means of the mirror array 31, through the transparent substrate 13, while the region (unirradiated region) in the resist 18 which is not irradiated with the light modulated by the mirror array 31 is reduced, in a stepwise fashion, in the breadthways direction.

The procedure for correcting light exposure and other beneficial effects are common to those of the first embodiment.

The multiple irradiation by the mirror array in the step S103 in FIG. 10 is described above.

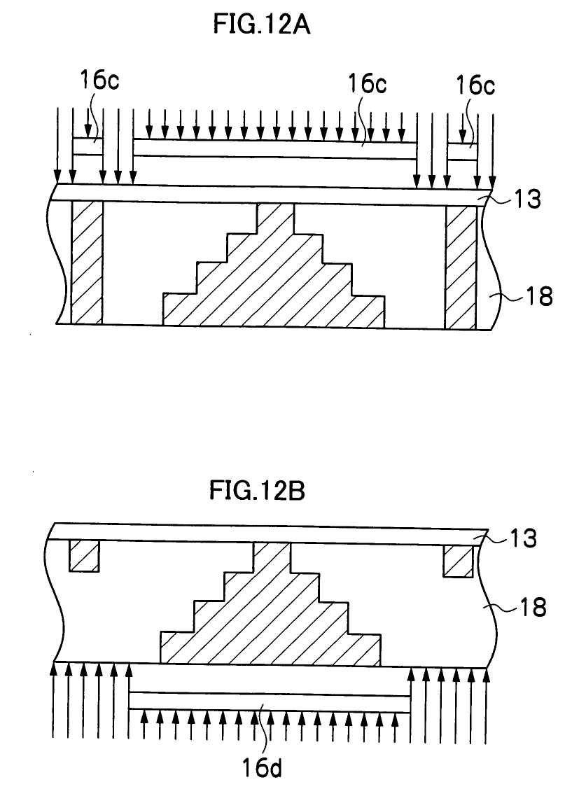

Thereupon, following the exposure using the mirror array, further exposure using a mask (mask light exposure) is carried out in order to form grooves (step S104). FIGS. 12A and 12B are illustrative diagrams of the mask light exposure for forming grooves 14.

As shown in FIG. 12A, a mask 16c is provided in front of the transparent substrate 13, and then exposure is carried out. In this case, the exposure (one-shot exposure) is carried out for the entire transparent substrate 13. The extent of the light exposure in the depth direction is adjusted by controlling the amount of the exposure light. Moreover, the mask 16c has a width and a figure required for forming the grooves 14. Thus, the portion of the resist 18 indicated by the non-hatched area in FIG. 12A is newly softened.

Thereupon, as shown in FIG. 122B, a mask 16d is provided on the side of the resist 18 reverse to the surface on which the transparent substrate 13 is provided, and then one-shot exposure is carried out for the entire area of the transparent substrate 13. In this case, the exposure is controlled in such a manner that the exposure light is radiated to a position corresponding to the bottom of the grooves described later, in the depth direction. Thereby, the portion of the resist 18 indicated by the non-hatched area in FIG. 12B is newly softened.

As described above, at the step S104 in FIG. 10, the masked light exposure is carried out in order to form the grooves.

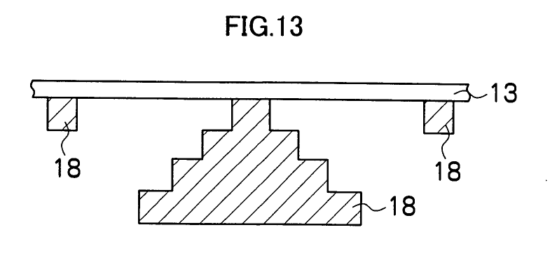

Thereupon, in a developing step, a developing process and post-baking are carried out (step S105). By carrying out this developing process, the portions of the resist 18 which have been softened at steps S103 and S104 is removed. By carrying out the post-baking, the solvent is made to evaporate from the resist 18 and the adhesion of the resist to the transparent substrate 13 is improved. As a result, a portion of the resist 18 having a shape in which the internal diameter reduces toward the transparent substrate 13, and the other portion of the resist 18 having a width equal to the groove width, described below, are obtained, as shown in FIG. 13.

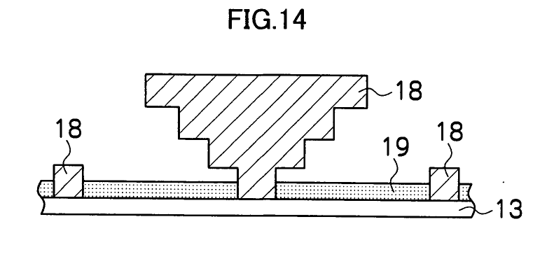

Thereupon, a Ni eutectoid plating is carried out in a plating step (step S 106). FIG. 14 is a diagram showing a state after Ni eutectoid plating 19 has been carried out on the resist thus developed. The plating material contains fluoride, and the plating thickness is 1 to 3 μm. This plating displays beneficial effects as a liquid repelling film (a film lacking an affinity for the liquid to be used).

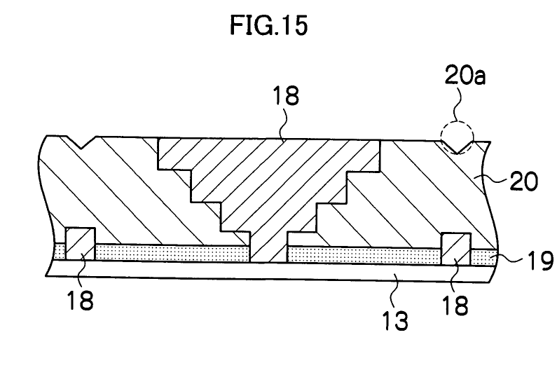

Thereupon, in an electroforming step, Ni electroforming is carried out (step S107). More specifically, a nozzle plate is formed by electrodeposition of nickel (Ni) to a prescribed thickness equal to or less than the height of the resist pattern. In this case, the transparent substrate 13 on which the remaining resist layer forms a resist pattern, is used as a cathode for electrodeposition of Ni. FIG. 15 is a diagram showing the state after carrying out the Ni electroforming. In this way, a nozzle plate made of nickel (Ni) is manufactured by reduction deposition of nickel (Ni) by using the electroforming method, and the plate has good rigidity as well as good wetting properties.

In this case, depressions 20a are formed in the Ni electroforming layer 20 in the portions, which are indicated by the dotted circle in FIG. 15. These depressions 20a are used as grooves.

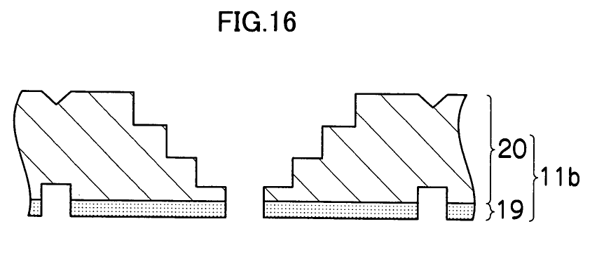

Next, in a removal and detachment step, the resist is removed and the transparent substrate is detached (step S108). FIG. 16 shows the completed nozzle plate 11b.

Thereupon, in a head bonding step, a print head is bonded to the completed nozzle plate 11b (step S109).

Other beneficial effects are common to those of the first embodiment.

The method of manufacturing a nozzle plate according to a second embodiment is described above.

### Structure of the Head

Next, the structure of a head forming a specific application embodiment of a nozzle plate manufactured by the manufacturing methods described above is explained below. The heads 112K, 112C, 112M and 112Y of the respective ink colors have the same structure, and a reference numeral 150 is used below to designate a representative embodiment of the heads.

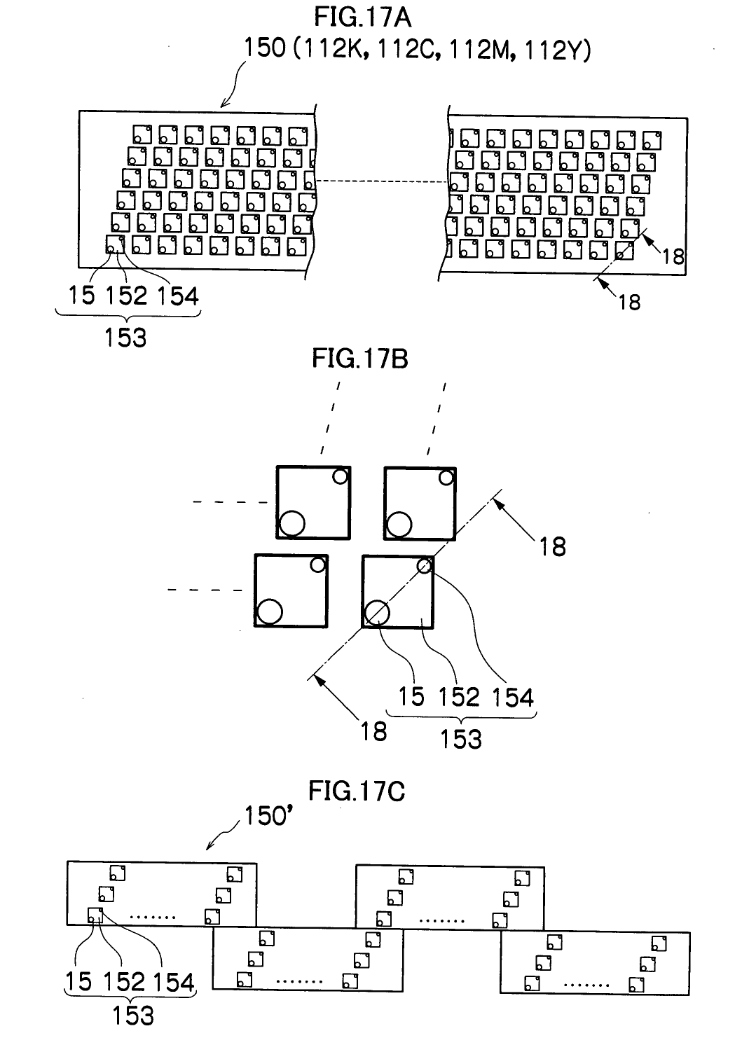

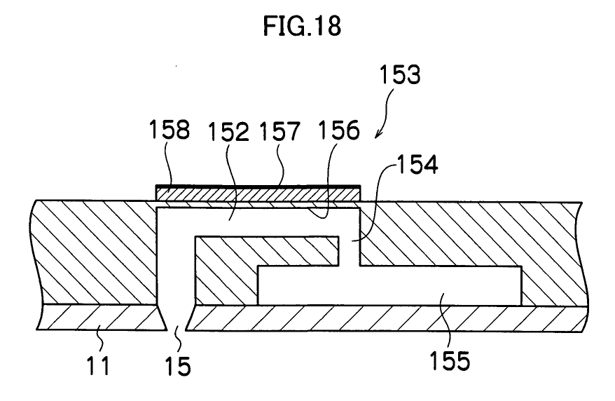

FIG. 17A is a plan view perspective diagram showing an embodiment of the structure of a head 150, and FIG. 17B is an enlarged diagram of a portion of same. Furthermore, FIG. 17C is a plan view perspective diagram showing a further embodiment of the composition of a print head 150. FIG. 18 is a cross-sectional diagram along line 18-18 in FIGS. 17A and 17B, and FIG. 18 shows a composition of one liquid droplet ejection element (one ink chamber unit corresponding to one nozzle 15).

In order to achieve a high density of the dot pitch printed onto the surface of the recording paper 116, it is necessary to achieve a high density of the nozzle pitch in the head 150. As shown in FIGS. 17A and 17B, each ink chamber unit (liquid droplet ejection element) 153 includes a nozzle 15 forming an ink ejection port, a pressure chamber 152 corresponding to the nozzle 15, and the like, and the head 150 according to the present embodiment has a structure in which a plurality of ink chamber units 153 are disposed (two-dimensionally) in the form of a staggered matrix. Hence, the effective nozzle interval (the projected nozzle pitch) as projected in the lengthwise direction (the direction perpendicular to the paper conveyance direction) of the head is reduced (high nozzle density is achieved).

The mode of forming one or more nozzle rows through a length corresponding to the entire width of the recording paper 116 in a direction substantially perpendicular to the conveyance direction of the recording paper 116 is not limited to the embodiment described above. For example, instead of the composition in FIG. 17A, as shown in FIG. 17C, a line head having nozzle rows of a length corresponding to the entire length of the recording paper 116 can be formed by arranging and combining, in a staggered matrix, short head modules 150′ having a plurality of nozzles 15 arrayed in a two-dimensional fashion.

As shown in FIGS. 17A and 17B, the planar shape of a pressure chamber 152 provided corresponding to each nozzle 15 is substantially a square shape, and an outlet port to the nozzle 15 is provided at one of the ends of the diagonal line of the planar shape, while an inlet port (supply port) 154 for supplying ink is provided at the other end thereof. The shape of the pressure chamber 152 is not limited to that of the present embodiment and various modes are possible in which the planar shape is a quadrilateral shape (diamond shape, rectangular shape, or the like), a pentagonal shape, a hexagonal shape, or other polygonal shape, or a circular shape, elliptical shape, or the like.

As shown in FIG. 18, each pressure chamber 152 is connected to a common flow passage 155 via the supply port 154. The common flow channel 155 is connected to an ink tank (not shown), which is a base tank that supplies ink, and the ink supplied from the ink tank is delivered through the common flow channel 155 to the pressure chambers 152.

An actuator 158 provided with an individual electrode 157 is bonded to a pressure plate (a diaphragm that also serves as a common electrode) 156 which forms the surface of one portion (in FIG. 18, the ceiling) of the pressure chambers 152. When a drive voltage is applied to the individual electrode 157 and the common electrode, the actuator 158 deforms, thereby changing the volume of the pressure chamber 152. This causes a pressure change which results in ink being ejected from the nozzle 15. For the actuator 158, it is possible to adopt a piezoelectric element using a piezoelectric body, such as lead zirconate titanate, barium titanate, or the like. When the displacement of the actuator 158 returns to its original position after ejecting ink, the pressure chamber 152 is replenished with new ink from the common flow channel 155, via the supply port 154.

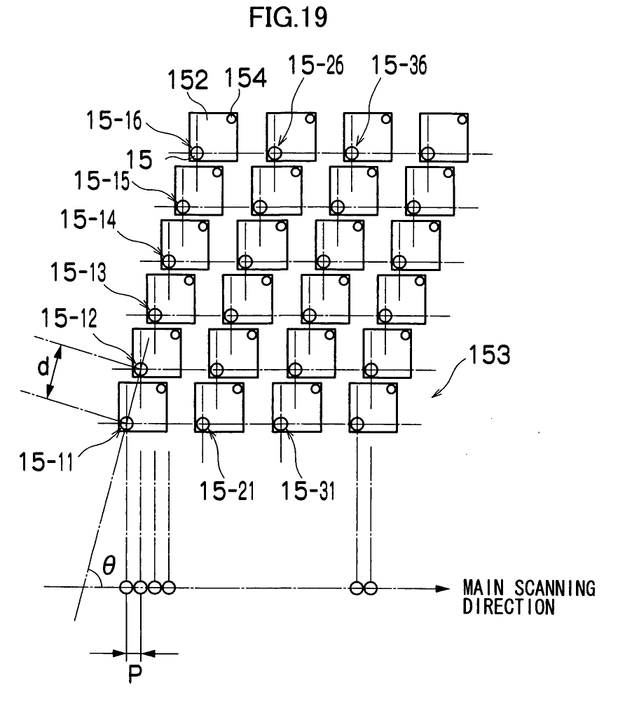

As shown in FIG. 19, the high-density nozzle head according to the present embodiment is achieved by composing a plurality of ink chamber units 153 having this structure in a lattice arrangement, based on a fixed arrangement pattern having a row direction which coincides with the main scanning direction, and a column direction which is inclined at a fixed angle of θ with respect to the main scanning direction, rather than being perpendicular to the main scanning direction.

More specifically, by adopting a structure in which a plurality of ink chamber units 153 are arranged at a uniform pitch d in line with a direction forming an angle of θ with respect to the main scanning direction, the pitch P of the nozzles projected to an alignment in the main scanning direction is d×cos θ, and hence it is possible to treat the nozzles 15 as if they are arranged linearly at a uniform pitch of P. By means of this composition, it is possible to achieve a nozzle composition of high density, in which the nozzle columns projected to an alignment in the main scanning direction reach a total of 2400 per inch (2400 nozzles per inch).

In a full-line head comprising rows of nozzles that have a length corresponding to the entire width of the image recordable width, the “main scanning” is defined as printing one line (a line formed of a row of dots, or a line formed of a plurality of rows of dots) in the width direction of the recording paper (the direction perpendicular to the conveyance direction of the recording paper) by driving the nozzles in one of the following ways: (1) simultaneously driving all the nozzles; (2) sequentially driving the nozzles from one side toward the other; and (3) dividing the nozzles into blocks and sequentially driving the blocks of the nozzles from one side toward the other.

In particular, when the nozzles 15 arranged in a matrix configuration such as that shown in FIG. 19 are driven, it is desirable that main scanning is performed in accordance with (3) described above. In other words, taking the nozzles 15-11, 15-12, 15-13, 15-14, 15-15 and 15-16 as one block (and furthermore, taking nozzles 15-21, . . . , 15-26 as one block, and nozzles 15-31, . . . , 15-36 as one block), one line is printed in the breadthways direction of the recording paper 116 by sequentially driving the nozzles 15-11, 15-12, . . . , 15-16 in accordance with the conveyance speed of the recording paper 116.

On the other hand, “sub-scanning” is defined as to repeatedly perform printing of one line (a line formed of a row of dots, or a line formed of a plurality of rows of dots) formed by the main scanning, while moving the full-line head and the recording paper relatively to each other.

The direction indicated by one line (or the lengthwise direction of a band-shaped region) recorded by main scanning as described above is called the “main scanning direction”, and the direction in which sub-scanning is performed, is called the “sub-scanning direction”. In other words, in the present embodiment, the conveyance direction of the recording paper 116 is called the sub-scanning direction and the direction perpendicular to same is called the main scanning direction.

In implementing the present invention, the arrangement of the nozzles is not limited to that of the embodiment illustrated. Furthermore, in the present embodiment, a method is employed in which an ink droplet is ejected by means of the deformation of the actuator 158, which is typically a piezoelectric element. However, in implementing the present invention, the method used for ejecting ink is not limited in particular, and instead of a piezo jet method, it is also possible to apply various types of methods, such as a thermal jet method, where the ink is heated and bubbles are caused to form therein by means of a heat generating body such as a heater, ink droplets being ejected by means of the pressure created by these bubbles.

### Composition of Inkjet Recording Apparatus

Next, the inkjet recording apparatus will be described.

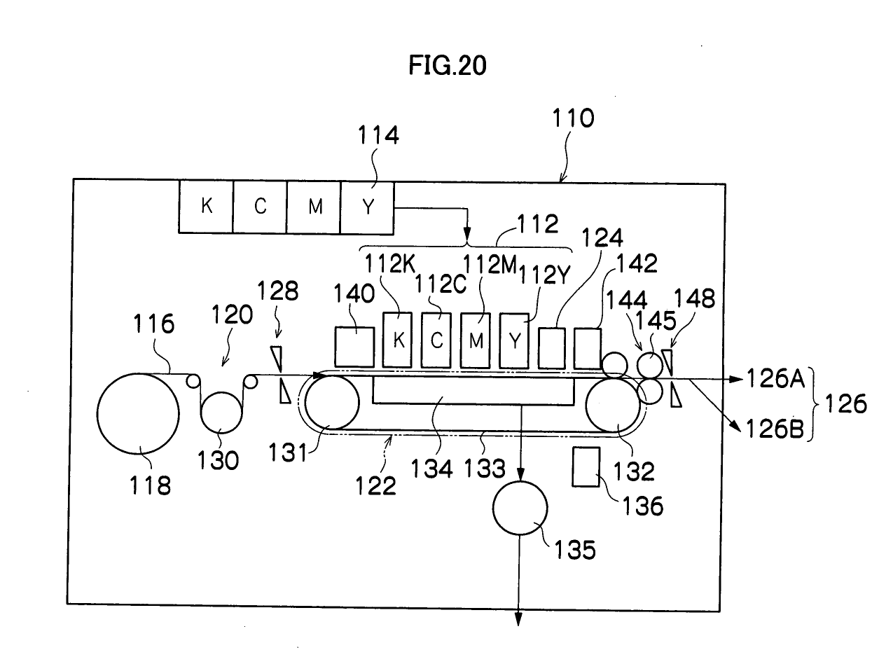

FIG. 20 is a general configuration diagram of an inkjet recording apparatus showing an embodiment of an image forming apparatus according to an embodiment of the present invention. As shown in FIG. 20, the inkjet recording apparatus 110 comprises: a printing unit 112 having a plurality of inkjet recording heads (hereafter, called “heads”) 112K, 112C, 112M, and 112Y provided for ink colors of black (K), cyan (C), magenta (M), and yellow (Y), respectively; an ink storing and loading unit 114 for storing inks of K, C, M and Y to be supplied to the print heads 112K, 112C, 112M, and 112Y; a paper supply unit 118 for supplying recording paper 116 which is a recording medium; a decurling unit 120 removing curl in the recording paper 116; a belt conveyance unit 122 disposed facing the nozzle face (ink-droplet ejection face) of the printing unit 112, for conveying the recording paper 116 while keeping the recording paper 116 flat; a print determination unit 124 for reading the printed result produced by the printing unit 112; and a paper output unit 126 for outputting image-printed recording paper (printed matter) to the exterior.

The ink storing and loading unit 114 has ink tanks for storing the inks of K, C, M and Y to be supplied to the heads 112K, 112C, 112M, and 112Y, and the tanks are connected to the heads 112K, 112C, 112M, and 112Y by means of prescribed channels. The ink storing and loading unit 114 has a warning device (for example, a display device or an alarm sound generator) for warning when the remaining amount of any ink is low, and has a mechanism for preventing loading errors among the colors.

In FIG. 20, a magazine for rolled paper (continuous paper) is shown as an embodiment of the paper supply unit 118; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which a plurality of types of recording medium can be used, it is preferable that an information recording medium such as a bar code and a wireless tag containing information about the type of media is attached to the magazine, and by reading the information contained in the information recording medium with a predetermined reading device, the type of recording medium to be used (type of medium) is automatically determined, and ink-droplet ejection is controlled so that the ink-droplets are ejected in an appropriate manner in accordance with the type of medium.

The recording paper 116 delivered from the paper supply unit 118 retains curl due to having been loaded in the magazine. In order to remove the curl, heat is applied to the recording paper 116 in the decurling unit 120 by a heating drum 130 in the direction opposite from the curl direction in the magazine. The heating temperature at this time is preferably controlled so that the recording paper 116 has a curl in which the surface on which the print is to be made is slightly round outward.

In the case of the configuration in which roll paper is used, a cutter (first cutter) 128 is provided as shown in FIG. 20, and the continuous paper is cut into a desired size by the cutter 128. When cut papers are used, the cutter 128 is not required.

The decurled and cut recording paper 116 is delivered to the belt conveyance unit 122. The belt conveyance unit 122 has a configuration in which an endless belt 133 is set around rollers 131 and 132 so that the portion of the endless belt 133 facing at least the nozzle face of the printing unit 112 and the sensor face of the print determination unit 124 forms a horizontal plane (flat plane).

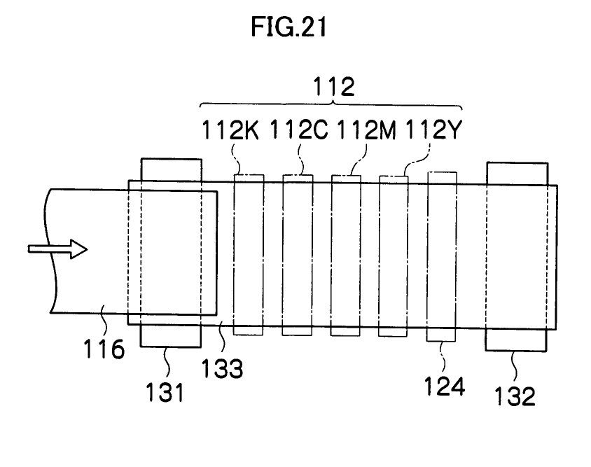

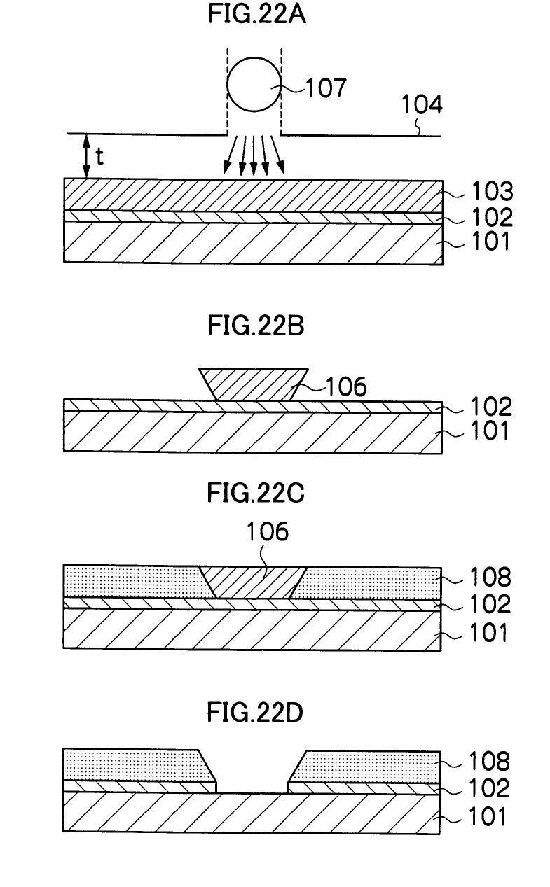

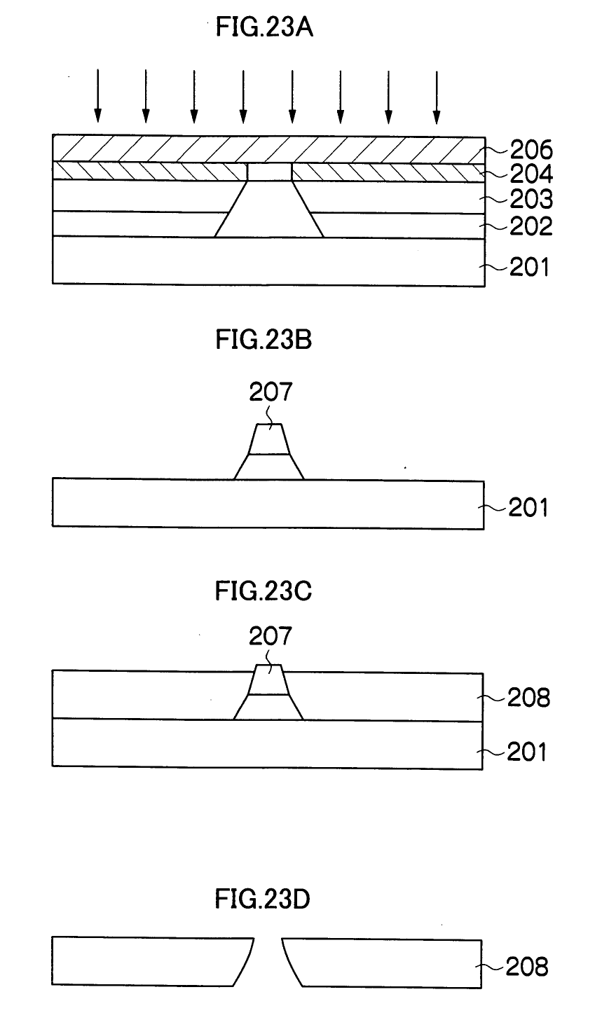

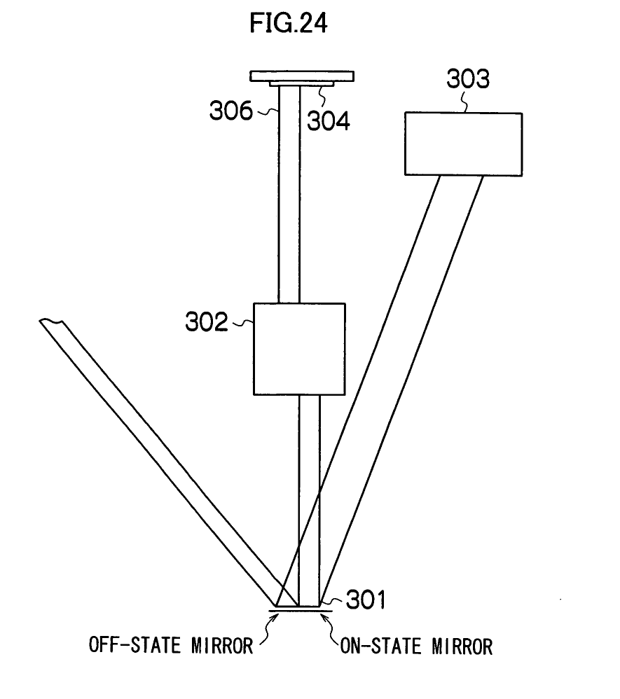

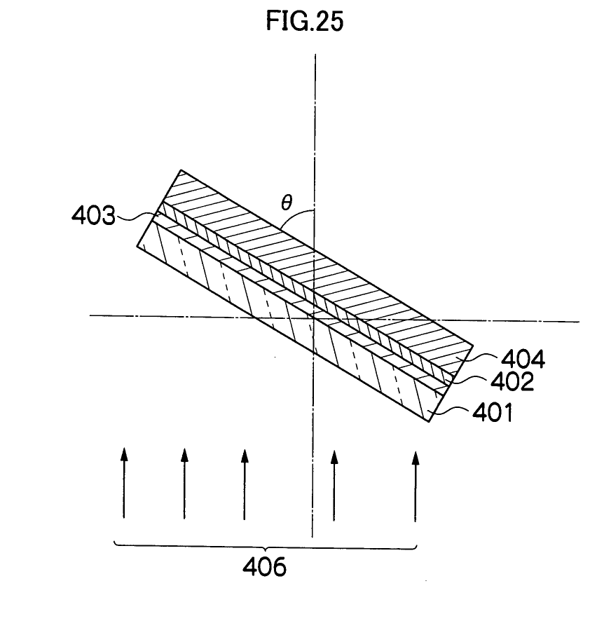

The belt 133 has a width that is greater than the width of the recording paper 116, and a plurality of suction apertures (not shown) are formed on the belt surface. A suction chamber 134 is disposed at a position facing the sensor surface of the print determination unit 124 and the nozzle surface of the printing unit 112 on the interior side of the belt 133, which is set around the rollers 131 and 132, as shown in FIG. 21. The suction chamber 134 provides suction with a fan 135 to generate a negative pressure, and the recording paper 116 is held on the belt 133 by suction. In place of the suction system, the electrostatic attraction system can be employed.

The belt 133 is driven in the clockwise direction in FIG. 21 by the motive force of a motor being transmitted to at least one of the rollers 131 and 132, which the belt 133 is set around, and the recording paper 116 held on the belt 133 is conveyed from left to right in FIG. 21.

Since ink adheres to the belt 133 when a marginless print job or the like is performed, a belt-cleaning unit 136 is disposed in a predetermined position (a suitable position outside the printing area) on the exterior side of the belt 133. Although the details of the configuration of the belt-cleaning unit 136 are not shown, embodiments thereof include a configuration in which the belt 133 is nipped with cleaning rollers such as a brush roller and a water absorbent roller, an air blow configuration in which clean air is blown onto the belt 133, or a combination of these. In the case of the configuration in which the belt 133 is nipped with the cleaning rollers, it is preferable to make the line velocity of the cleaning rollers different than that of the belt 133 to improve the cleaning effect.

The inkjet recording apparatus 110 can comprise a roller nip conveyance mechanism, in which the recording paper 116 is pinched and conveyed with nip rollers, instead of the belt conveyance unit 122. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 140 is disposed on the upstream side of the printing unit 112 in the conveyance pathway formed by the belt conveyance unit 122. The heating fan 140 blows heated air onto the recording paper 116 to heat the recording paper 116 immediately before printing so that the ink deposited on the recording paper 116 dries more easily.

The heads 112K, 112C, 112M and 112Y of the printing unit 112 are full line heads having a length corresponding to the maximum width of the recording paper 116 used with the inkjet recording apparatus 110, and comprising a plurality of nozzles for ejecting ink arranged on a nozzle face through a length exceeding at least one edge of the maximum-size recording medium (namely, the full width of the printable range) (see FIG. 21).

The print heads 112K, 112C, 112M and 112Y are arranged in color order (black (K), cyan (C), magenta (M), yellow (Y)) from the upstream side in the feed direction of the recording paper 116, and these respective heads 112K, 112C, 112M and 112Y are fixed extending in a direction substantially perpendicular to the conveyance direction of the recording paper 116.

A color image can be formed on the recording paper 116 by ejecting inks of different colors from the heads 112K, 112C, 112M and 112Y, respectively, onto the recording paper 116 while the recording paper 116 is conveyed by the belt conveyance unit 122.

By adopting a configuration in which the full line heads 112K, 112C, 112M and 112Y having nozzle rows covering the full paper width are provided for the respective colors in this way, it is possible to record an image on the full surface of the recording paper 116 by performing just one operation of relatively moving the recording paper 116 and the printing unit 112 in the paper conveyance direction (the sub-scanning direction), in other words, by means of a single sub-scanning action. Higher-speed printing is thereby made possible and productivity can be improved in comparison with a shuttle type head configuration in which a recording head reciprocates in the main scanning direction.

Although the configuration with the KCMY four standard colors is described in the present embodiment, combinations of the ink colors and the number of colors are not limited to those. Light inks, dark inks or special color inks can be added as required. For example, a configuration is possible in which inkjet heads for ejecting light-colored inks such as light cyan and light magenta are added. Furthermore, there are no particular restrictions of the sequence in which the heads of respective colors are arranged.

The print determination unit 124 shown in FIG. 20 has an image sensor (line sensor or area sensor) for capturing an image of the ink-droplet deposition result of the printing unit 112, and functions as a device to check for ejection characteristics such as clogs of the nozzles or ink depositing position deviation from the ink-droplet deposition results evaluated by the image sensor.

A CCD area sensor in which a plurality of photoreceptor elements (photoelectric transducers) are arranged on the light receiving surface is suitable for use as the print determination unit 124 of the present embodiment. An area sensor has an imaging range which is capable of capturing an image of at least the full area of the ink ejection width (image recording width) of the respective heads 112K, 112C, 112M and 112Y. It is possible to achieve the required imaging range by means of one area sensor, or alternatively, it is also possible to ensure the required imaging range by combining (joining) a plurality of area sensors. Alternatively, a composition may be adopted in which the area sensor is supported on a movement mechanism (not illustrated), and an image of the required imaging range is captured by moving (scanning) the area sensor.

Furthermore, it is also possible to use a line sensor instead of the area sensor. In this case, a desirable composition is one in which the line sensor has rows of photoreceptor elements (rows of photoelectric transducing elements) with a width that is greater than the ink droplet ejection width (image recording width) of the print heads 112K, 112C, 112M and 112Y. A test pattern or the target image printed by the print heads 112K, 112C, 112M, and 112Y of the respective colors is read in by the print determination unit 124, and the ejection performed by each head is determined. The ejection determination includes the presence of ejection, measurement of the dot size, measurement of the dot depositing position, and the like.

A post-drying unit 142 is disposed following the print determination unit 124. The post-drying unit 142 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming into contact with ozone and other substance that cause dye molecules to break down, and has the effect of increasing the durability of the print.

A heating/pressurizing unit 144 is disposed following the post-drying unit 142. The heating/pressurizing unit 144 is a device to control the glossiness of the image surface, and the image surface is pressed with a pressure roller 145 having a predetermined uneven surface shape while the image surface is heated, and the uneven shape is transferred to the image surface.

The printed matter generated in this manner is outputted from the paper output unit 126. The target print (i.e., the result of printing the target image) and the test print are preferably outputted separately. In the inkjet recording apparatus 110, a sorting device (not shown) is provided for switching the outputting pathways in order to sort the printed matter with the target print and the printed matter with the test print, and to send them to paper output units 126A and 126B, respectively. When the target print and the test print are simultaneously formed in parallel on the same large sheet of paper, the test print portion is cut and separated by a cutter (second cutter) 148. Although not shown in FIG. 20, the paper output unit 126A for the target prints is provided with a sorter for collecting prints according to print orders.

Methods of manufacturing a nozzle plate, liquid droplet ejection heads and image forming apparatuses according to embodiments of the present invention have been described in detail above, but the present invention is not limited to the aforementioned embodiments, and it is of course possible for improvements or modifications of various kinds to be implemented, within a range which does not deviate from the essence of the present invention.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A method of manufacturing a nozzle plate, the method comprising the steps of:
forming a photosensitive film of a negative type photosensitive material on a transparent plate having light transmission characteristics, the photosensitive film being demarcated into an unirradiated region and an irradiated region; and
performing exposure of the photosensitive film to light transmitted via a spatial modulation element and the transparent plate, in such a manner that the unirradiated region is not irradiated with the light and the irradiated region is irradiated with the light,
wherein, during the exposure of the photosensitive film, change of the unirradiated region is successively performed and change of a time interval when the irradiated region is irradiated with the light is performed in accordance with the change of the unirradiated region.

2. A method of manufacturing a nozzle plate, the method comprising the steps of:
forming a photosensitive film of a positive type photosensitive material on a transparent plate having light transmission characteristics, the photosensitive film being demarcated into an unirradiated region and an irradiated region;
performing exposure of the photosensitive film to light transmitted via a spatial modulation element and the transparent plate, in such a manner that the unirradiated region is not irradiated with the light and the irradiated region is irradiated with the light;
developing the photosensitive film after the exposure of the photosensitive film; and
electroforming a metal member by using the photosensitive film which has been developed for a mold,
wherein, during the exposure of the photosensitive film, change of the unirradiated region is successively performed and change of a time interval when the irradiated region is irradiated with the light is performed in accordance with the change of the unirradiated region.

3. The method of manufacturing a nozzle plate as defined in claim 1, wherein:
during the exposure of the photosensitive film, the change of the unirradiated region is successively performed in such a manner that the unirradiated region becomes narrower successively; and
during the exposure of the photosensitive film, the change of the time interval when the irradiated region is irradiated with the light is performed in such a manner that the time interval is shortened in accordance with narrowing of the unirradiated region.

4. The method of manufacturing a nozzle plate as defined in claim 2, wherein:
during the exposure of the photosensitive film, the change of the unirradiated region is successively performed in such a manner that the unirradiated region becomes narrower successively; and
during the exposure of the photosensitive film, the change of the time interval when the irradiated region is irradiated with the light is performed in such a manner that the time interval is shortened in accordance with narrowing of the unirradiated region.

5. The method of manufacturing a nozzle plate as defined in claim 1, wherein at least one of the change of the unirradiated region and the change of the time interval is controlled in accordance with characteristics of the light which passes through the photosensitive film.

6. The method of manufacturing a nozzle plate as defined in claim 2, wherein at least one of the change of the unirradiated region and the change of the time interval is controlled in accordance with characteristics of the light which passes through the photosensitive film.

7. The method of manufacturing a nozzle plate as defined in claim 1, further comprising the step of forming a first groove having a diameter smaller than a maximum diameter of the unirradiated region, in a surface of the photosensitive film reverse to a surface of the photosensitive film on which the transparent plate is arranged.

8. The method of manufacturing a nozzle plate as defined in claim 2, further comprising the step of forming a first groove having a diameter smaller than a maximum diameter of the unirradiated region, in a surface of the metal member reverse to a surface of the metal member on which the transparent plate is arranged.

9. The method of manufacturing a nozzle plate as defined in claim 1, wherein a cross-sectional shape of the unirradiated region which has a maximum space differs from a cross-sectional shape of the unirradiated region which has a minimum space.

10. The method of manufacturing a nozzle plate as defined in claim 2, wherein a cross-sectional shape of the unirradiated region which has a maximum space differs from a cross-sectional shape of the unirradiated region which has a minimum space.

11. The method of manufacturing a nozzle plate as defined in claim 1, wherein:
the unirradiated region has a projecting section which extends outward; and
a phase of the projecting section of the unirradiated region changes successively in accordance with the change of the unirradiated region.

12. The method of manufacturing a nozzle plate as defined in claim 2, wherein:
the unirradiated region has a projecting section which projects outward; and
a phase of the projecting section of the unirradiated region changes successively in accordance with the change of the unirradiated region.

13. The method of manufacturing a nozzle plate as defined in claim 1, further comprising the step of forming a second groove in a surface of the photosensitive film on which the transparent plate is arranged.

14. The method of manufacturing a nozzle plate as defined in claim 2, further comprising the step of forming a second groove in a surface of the metal member on which the transparent plate is arranged.

15. A liquid ejection head comprising a nozzle plate manufactured by the method of manufacturing a nozzle as defined in claim 1.

16. A liquid ejection head comprising a nozzle plate manufactured by the method of manufacturing a nozzle as defined in claim 2.

17. An image forming apparatus comprising the liquid ejection head as defined in claim 15.

18. An image forming apparatus comprising the liquid ejection head as defined in claim 16.
